(19) United States
(12) Patent Application Publication
(10) Pub. No.: US 2009/0285392 A1
(43) Pub. Date: Nov. 19, 2009

(54) Real-Time Help Services for Web Applications

(75) Inventors: Gregory Leitheiser, Coppell, TX (US); Charles Stanley Fenton, Ypsilanti, MI (US)

Correspondence Address: AT&T Legal Department - JW;Attn: Patent Docketing, Room 2A-207, One AT&T Way, Bedminster, NJ, 07921, US

(73) Assignee: AT&T KNOWLEDGE VENTURES, L.P., Reno, NV (US)

(21) Appl. No.: 12/121,597

(22) Filed: May 15, 2008

(51) Int. Cl. G06F 15/16; H04L 9/30

(52) U.S. Cl. 380/255; 709/203; 709/227

(57) ABSTRACT

A help service includes proxying a web application page between a user web browser and a web application server. The help service includes providing the web application page to a customer service representative (CSR) web browser and opening a live communication channel for human communication between a user and a customer service representative. In some embodiments, from within a user network, a user help request is generated from a user web browser and received from a help server. The web application page may be transmitted over the Internet to the CSR web browser. In some embodiments, the CSR web browser may operate as a COMET client, the user web browser may act as an AJAX server-side processor, and the user web browser may operate as a COMET client for receiving updates to the web application page.

### BACKGROUND

1. Field of the Disclosure

The present disclosure generally relates to software applications and more particularly to providing real-time help services for software applications.

2. Description of the Related Art

Users of software applications may seek instruction from help representatives for issues related to the software applications. Help representatives may be unable to view the same information (e.g., screen images) that is seen by the user.

### BRIEF DESCRIPTION OF THE DRAWINGS

FIG. 1 depicts a user web browser communicating with a web application prior to establishing a help session in accordance with disclosed embodiments;

FIG. 2 depicts a setting in which a user of a web application receives real-time help from a service representative in accordance with disclosed embodiments;

FIG. 3 depicts selected operations for establishing a real-time help session in accordance with disclosed embodiments;

FIG. 4 depicts selected operations for establishing real-time help session in accordance with disclosed embodiments;

FIG. 5 depicts a graphical user interface for an embodied a real-time help service;

FIG. 6 illustrates example screen shots from a user's web browser and a corresponding screen shot from a customer service representative's web browser during a real-time communication session operated in accordance with disclosed embodiments;

FIG. 7 illustrates an environment in which a user operating a web browser over a user network receives real-time help services in accordance with disclosed embodiments; and

FIG. 8 depicts an example data processing system that may be enabled as an application server, a web server, a help server, or as part of a network in accordance with disclosed embodiments.

### DESCRIPTION OF THE EMBODIMENT(S)

In one aspect, a help service includes proxying a first instance of a web application page between a user web browser and a web application server in response to a help request. In addition, the embodied help service includes providing an instance of the web application page to a customer service representative (“CSR”) web browser. Further, the embodied help service includes opening a live communication channel for communication between a user and a customer service representative. In some embodiments, from within a user network, a help request is both generated from a user web browser and received from a help server. In some embodiments, the second instance of the web application page is transmitted over the Internet to the CSR web browser. In some embodiments, server-side processing is provided to the CSR web browser. In such cases, the CSR web browser may operate as a COMET client for receiving updates to the second instance of the web application page. Activity generated by the user may generate events provided to the CSR web browser. In some embodiments, the help service further includes receiving server-side processing from the user web browser. In such cases, the user web browser may act as an AJAX server-side processor. The service may further include providing server-side processing to the user web browser, which may be a COMET client for receiving updates to the first instance of the web application page.

In another aspect, a method of providing real-time help sessions includes establishing a browser channel through a help server in response to a user requesting help with a user application. The help server acts as a proxy between a CSR web browser and a user web browser. The help server may be within a software provider network for hosting the user application. The method further includes establishing a communication channel for human communication between the user and the customer service representative. The communication channel may be for an instant message chat session or for voice over IP (VoIP) communication, as examples. In some embodiments, the communication channel bypasses the help server. The method may further include maintaining a COMET connection between the help server and a CSR web browser for sending data indicative of user actions through a help server queue module. In such cases, the data indicative of the user actions is for updating a CSR web browser. The user help request may result in the generation of an automated request for an application server of the user application to send a refreshed page of the user application. The refreshed page of the user application may include a JavaScript library that at least partially enables the browser channel. A version of the refreshed page may be delivered to a CSR web browser. This version may include a second JavaScript library for managing a COMET connection with the help server. Through the COMET connection, user actions may be pushed to the CSR's web browser substantially in real time.

In still another aspect, a server is for providing real-time help services for web applications. The server is for executing computer readable instructions stored on at least one computer readable media for enabling the server to receive a help request generated from a user web browser by a user selecting a help service. Further instructions enable the server to request a web application page from a web application server to establish a proxy connection between a user web browser and a CSR web browser. Instructions further enable the server to provide a first version of the web application page to the user web browser. The first version includes computer instructions that enable a browser channel to push, substantially in real-time, data indicative of user actions to the CSR web browser. Further instructions enable the server to provide a second version of the web application to the CSR web browser. The second version includes computer instructions for managing a COMET connection between the server and the CSR web browser. Some embodiments include further instructions that enable the server to link the browser channel to a live communication channel that is for human communication between the user and the customer service representative. The live communication channel may be an instant message chat channel or a voice over IP communication channel, as examples. Further instructions may enable the server to communicate with the CSR web browser over the Internet using public-key encryption.

The following description includes examples and details to enable one of ordinary skill in the art to practice the claimed subject matter without undue experimentation. It should be apparent to such a person that disclosed embodiments are included as examples and not exhaustive of all possible embodiments. In the drawings, the same reference numerals may be used throughout the views to represent the same or similar components.

As further background related to disclosed embodiments, providing real-time help for web-based applications may be difficult if a help representative is unable to see what a user is seeing on the user's browser. In many cases, a help representative can see a different instance of the same web application and must vocally coach the user through the multiple screens to resolve the user's issues. In such cases, there may be excessive strain on the user as he or she attempts to decipher instructions from the help representative and transfer the instructions into an understanding of the web application. The user is also, in some cases, required to describe accurately to the help representative various issues the user is having with the web application. In some cases, this may lead to a high degree of confusion between the user and the help representative. Help representatives may also use desktop sharing applications (e.g. WebEx, or NetMeeting) to share the user's electronic desktop for troubleshooting purposes. However, desktop sharing solutions may be seen by the user as overly invasive and many users are uncomfortable sharing their electronic desktops with outside entities. Moreover, these solutions may be resource intensive and require the installation of unwanted software on the user's machine.

Disclosed embodiments, in some cases, leverage voice over Internet protocol, asynchronous JavaScript, XML, AJAX, COMET, and JavaScript to proxy web application sessions to customer service representatives and users. In operation, an application session may be tied to a VoIP communication channel that allows the user to talk, send text messages, or send instant messages directly to the representative while using the application. In some embodiments, web application servers and help servers are Internet based. In other embodiments, web application servers and help servers are deployed at the user's location.

In some embodied systems, a user selects (e.g., by clicking an icon) an application (e.g., a web application) that links the user's data processing system to a live help system. The live help system may be software running on a server that proxies the application for the user. As the user continues to use the application, the help system sends a copy of the running application (e.g., through a browser channel) to a customer service queuing system and also initiates a communication session (e.g., VoIP based session or IM based session) with the user. When a customer service representative receives the communication, both the browser channel and the communication channel are opened. The customer service representative can directly see the application and actions the user undertakes, and can communicate directly with the user.

In some embodiments, when a user of an application (e.g., a web based software application) selects a help feature (e.g., clicks a “help” button), the user's browser sends a request to a help server. This request may include session identification data regarding the user's session. The request may also result in a page refresh from the application server that hosts the user application being sent through a help server that acts as a proxy. The resultant web page on the user end has a JavaScript library added which enables the help session features. As a result, any action taken by the user on the application is relayed to the help server. The resultant web page(s) is also copied, another JavaScript library added, and this page is sent to the service representative's browser. In some embodiments, the JavaScript library manages a COMET (i.e., reverse-AJAX) connection to the help server. Through this connection, the user's actions, mouse movements, and the like may be pushed to the service representative's browser substantially in real time (i.e., live communication as allowed by network latencies and the like). Accordingly, in accordance with disclosed embodiments, a browser channel is established and used during a help session between the user and the customer service representative.

In addition to the browser channel, a communication channel using VoIP or some other communication medium is started and linked to the browser channel by the help server. With the channels connected, the customer service representative can view the user's actions and communicate directly with the user about what the user and customer service representative are seeing simultaneously and in real time. In accordance with some disclosed embodiments, two otherwise disparate channels are effectively combined into a single, usable communication session. Authentication provided to the web application server or help server by the user can be used to identify the user without complex authentication protocols on the human communication channel (e.g., voice channel). Such operations may simplify establishing the human communication channel.

If the user's software is running within the user's local network, then help services may have an architecture with two distinct parts. A first part manages the proxying and session replication features on the user's network. A second part runs on the application provider's public network and manages queuing mechanisms. When a user requests help via the provided link, the first part may establish a session by connecting to the second part through the Internet. Such sessions may be secured (e.g., with public key encryption) if desired. Such solutions provide live, interactive support for remotely deployed products.

Some connections described herein are described with AJAX or COMET, as examples. The term “reverse AJAX” may refer to the use of AJAX for sending data, for example from a client to a server, and another mechanism for pushing server data back to the browser. A reverse AJAX system may have similar or identical features as server push, HTTP push, HTTP streaming, pushlets, and COMET. The term “COMET” as used herein may refer to a web architecture in which a web server sends data asynchronously to a client program, for example, a web browser. Further, when the web server sends data to the client program using COMET, there may be no need for the client program explicitly to request it. This allows the creation of event-driven applications and enables real-time interaction between applications. Accordingly, COMET applications typically rely on persistent connections that typically push new data (e.g., to a client) as the data becomes available on the server side. Applications that use COMET may differ from other applications, for example browsers, that receive a complete web page in response to each request. In addition, COMET applications may differ from AJAX applications, which may involve a browser requesting several pieces of data at once that are used to update a page. As described herein, some elements of disclosed embodiments may establish and operate COMET connections, for example. However, such terms do not necessarily refer to any specific technique for achieving such interaction between client and server, but is intended to encompass all such techniques. In addition, in some embodiments, JavaScript may be used rather than proprietary plug-ins to perform tasks as disclosed herein.

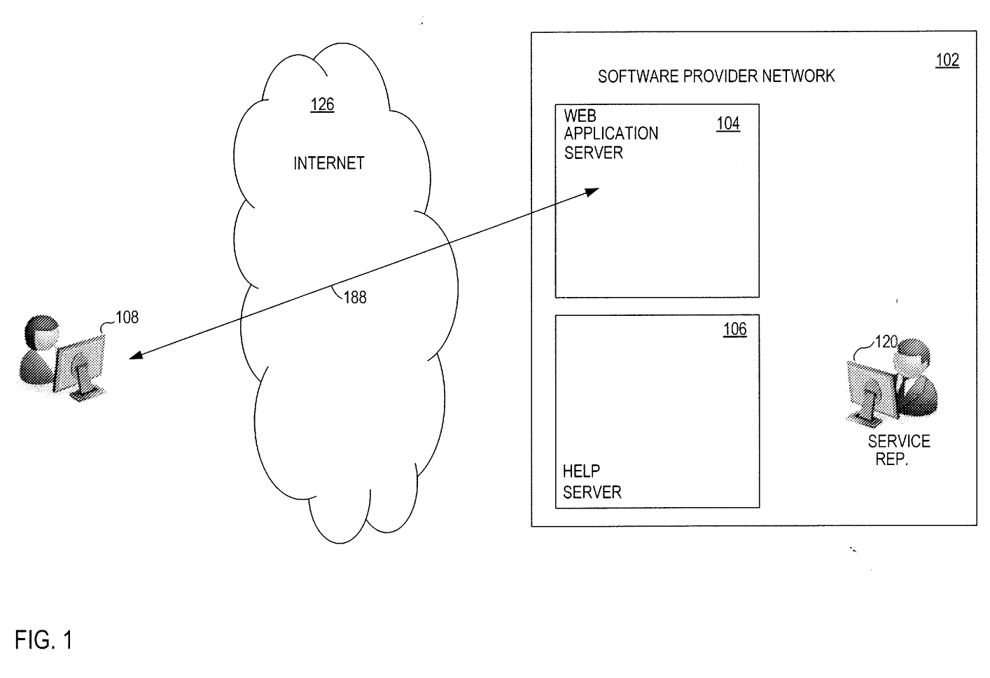

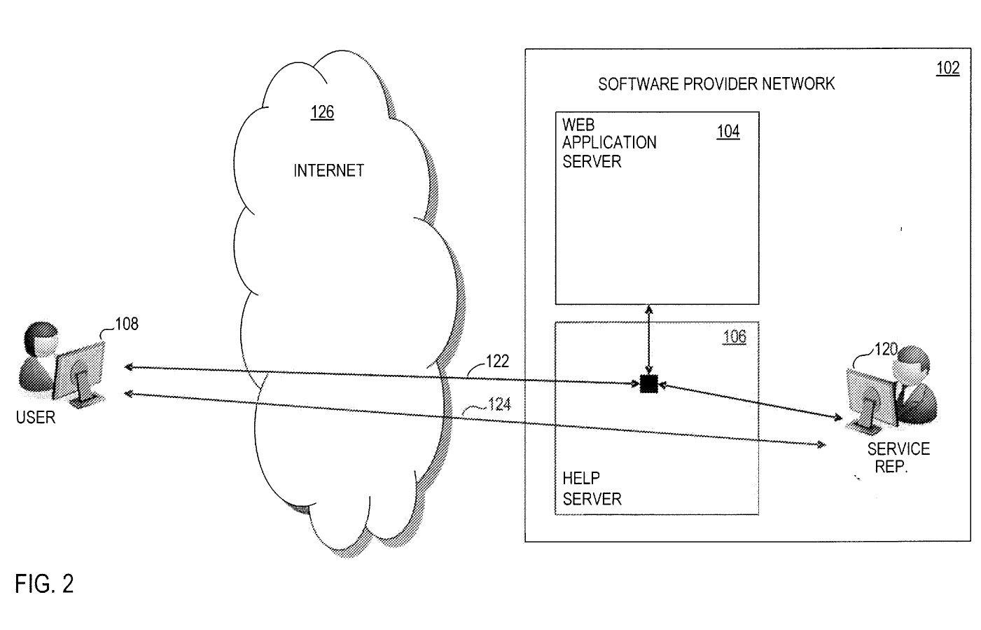

Referring now to the figures, FIG. 1 depicts a user web browser 108 communicating with a web application hosted by web application server 104. As shown, channel 188 is used for communication between the user web browser 108 and web application server 104 over network 126. Upon a user of user web browser 108 requesting help for the web application, user web browser 108 will have its web page refreshed as help server 106 acts as a proxy between web application server 104 and user web browser 108. In addition, [once the help session is established] CSR web browser 120 is provided with information regarding the web application hosted by application server 104. In this way, software provider network 102 is provisioned to allow CSR web browser 120 with real-time updates regarding pages viewed by user web browser 108 and actions taken by its user. FIG. 2 depicts an example of an embodied help service. As depicted in FIG. 2, web applications may be hosted over the Internet by application servers. Disclosed embodiments provide at least two channels of communication by establishing a communication channel 124 for human communication between the user of user web browser 108 and a customer service representative that operates CSR web browser 120. Examples of human communication enabled by communication channel 124 include VoIP sessions and real-time chat sessions (e.g., IM chat sessions). In response to the user of user web browser 108 requesting help regarding an application hosted by web application server 104, help server 106 establishes a browser channel 122. Through browser channel 122, CSR web browser 120 receives updates related to activity from the user of user web browser 108. By receiving live updates regarding activity (e.g., mouse movements, icon selection, typing) of the user, the customer service representative is able to better instruct and help the user over communication channel 124. As shown, user web browser 108 communicates over network 126, which may be the Internet or another network.

Accordingly, the components of FIG. 2 provide real-time help services to users of software applications (e.g., web applications). FIG. 2 illustrates an embodied service in operation at a point in which help server 106 is acting as a proxy. Prior to a help server 106 acting as a proxy, user web browser 108 may have direct access to web application server 104. However, in accordance with some embodiments, help server 106 receives a help request generated from user web browser 108 and undertakes the role of proxy for sending pages, page refreshes and page updates to user web browser 108 and CSR web browser 120. In response to receiving the help request, help server 106 requests a page from web application server 104. In such cases, the web application server 104 acts as a web application server that provides web application pages. Help server 106 receives web application pages (i.e., user application pages) that become proxied pages upon help server 106 providing copies, versions, or instances of the pages to user web browser 108 and CSR web browser 120.

Upon help server 106 receiving the web application pages, it notifies CSR web browser 120 (i.e., the customer service representative web browser) regarding the help request. In the alternative, help server 106 may notify CSR web browser 120 upon receiving the help request or the help request may be sent substantially simultaneously to help server 106 and CSR web server 120. In addition, help server 106 provides a first proxied page to user web browser 108 and a second proxied page to CSR web browser 120. Help server 106 acts as a proxy to enable data communication between user web browser 108, web application server 104, and CSR web browser 120. In addition, as shown, communication channel 124 is established for human communication between the user (of user web browser 108) and the customer service representative (that uses CSR web browser 120).

In some embodiments, help server 106 provides server-side processing to CSR web browser 120. In this configuration, CSR web browser 120 may serve as a COMET client for receiving updates to the second instance of the proxied page. Accordingly, activity by the user of user web browser 108 results in generated events and, as a COMET client of help server 106, CSR web browser 120 receives data related to the user-generated events asynchronously. This allows the customer service representative using CSR web browser 120 to provide meaningful feedback to the user of user web browser 108 over a real-time voice session or IM chat session on communication channel 124.

As shown in FIG. 2, help server 106 may receive server-side processing from user web browser 108 regarding user input and other events. In such a configuration, user web browser 108 acts as an AJAX server-side processor. Additionally, help server 106 provides server-side processing to the user web browser 108. In this configuration, user web browser 108 is a COMET client and may receive, for example, updates to the first instance of the proxied page.

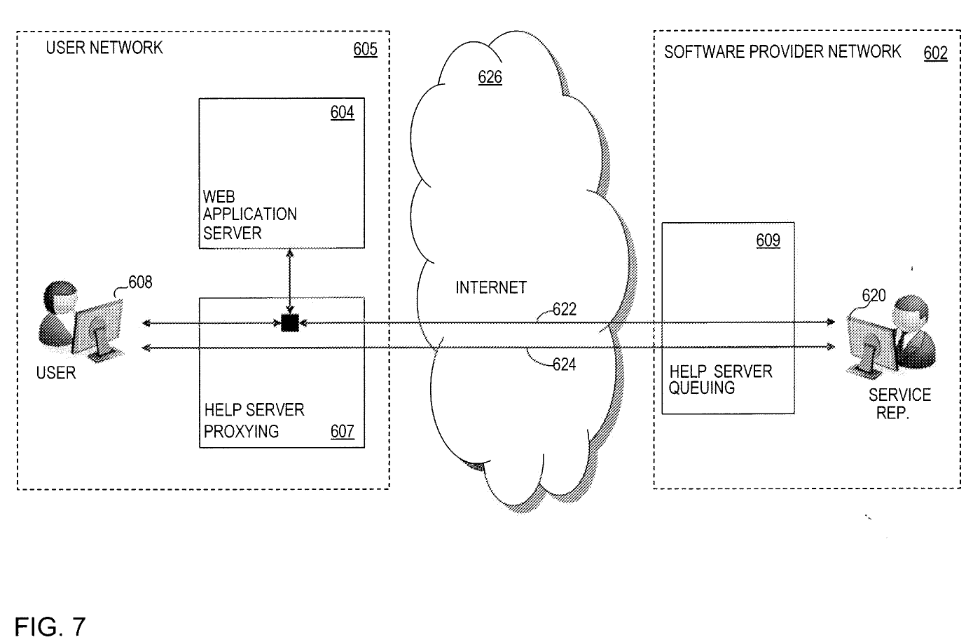

As shown, software provider network 102 hosts web application server 104 and help server 106. However, other configurations are possible including one in which the help request is generated from a network local to user web browser 108. In this configuration, providing a second instance of the proxied page to CSR web browser 120 (i.e., the customer service representative web browser) includes transmitting the second instance of the proxied page over network 126, as shown in FIG. 7.

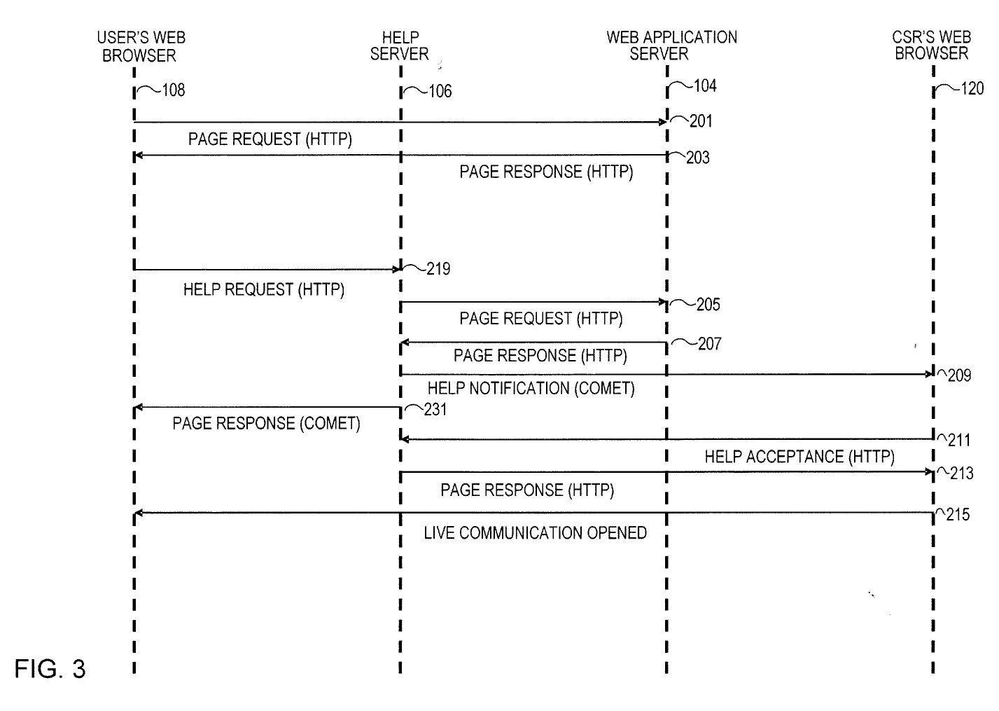

FIG. 3 depicts selected operations for establishing a live help session in accordance with disclosed embodiments. As shown, operation 201 relates to user web browser 108 sending a page request to web application server 104. Web application server 104 may be any web application server for providing access to news, shopping, data, and the like. As another example, web application server 104 may be operated by a bank and provide users with access to their deposits, receipts, stock trades, credit card purchases, or other data. Accordingly, in operation 201 a user may request account information for the user's bank accounts if web application server 104 is provided by the user's bank.

As shown, web application server 104 responds to operation 201 by sending a page response in operation 203. For example, web application server 104 may provide a page with account balances for the user. As shown, operation 201 and operation 203 may involve sending request responses using HTTP protocol. In response to operation 203 or possibly as a result of operation 203 failing to meet the user's needs, if the user (of user web browser 108) wishes to obtain help, the user may provide input (e.g., clicking on a “help” icon) which results in a help request that, as shown, is sent in operation 219 to help server 106. As an example scenario that results in a user help request, if the user of a bank-hosted web application has trouble finding a particular transaction for which he or she is searching, the user may request help. In addition or in the alternative, the user may have difficulty operating the application hosted by the web application server. Accordingly, the user may wish for a customer service representative to guide the user to the correct area of the web application. In accordance with disclosed embodiments, the customer service representative is provided with live updates that show a user's movements on an instance of a page that is copied to another instance of a page presented to the customer service representative.

To request help, the user may select an icon or “help” button on a toolbar in a graphical user interface (GUI) presented by user web browser 108 as provided by web application server 104. As shown, in response to the help request in operation 219, operation 205 results in sending a copy of the page request from the help server 106 to web application server 104. Operation 207 results in a page response being sent from web application server 104 to help server 106. Operation 209 results in help server 106 providing a help notification to CSR web browser 120, which is used by a customer service representative. As shown, operations 219, 205, and 207 may be accomplished using standard HTTP protocol. In contrast, as shown, operation 209 is performed using a COMET session between web application server 104 and CSR web browser 120. In such a configuration, web application server 104 acts to provide server-side processing and CSR web browser 120 is a COMET client for web application server 104 asynchronously to provide updates related to user actions for the user of user web browser 108. In operation 231, help server 106 provides a page response to user web browser 108. In operation 211, CSR web browser 120 provides help acceptance, for example using HTTP, to help server 106. In operation 213, help server 106 provides a page response, for example using HTTP, to CSR web browser 120. In operation 215, CSR web browser 120 establishes a live communication channel to user web browser 108.

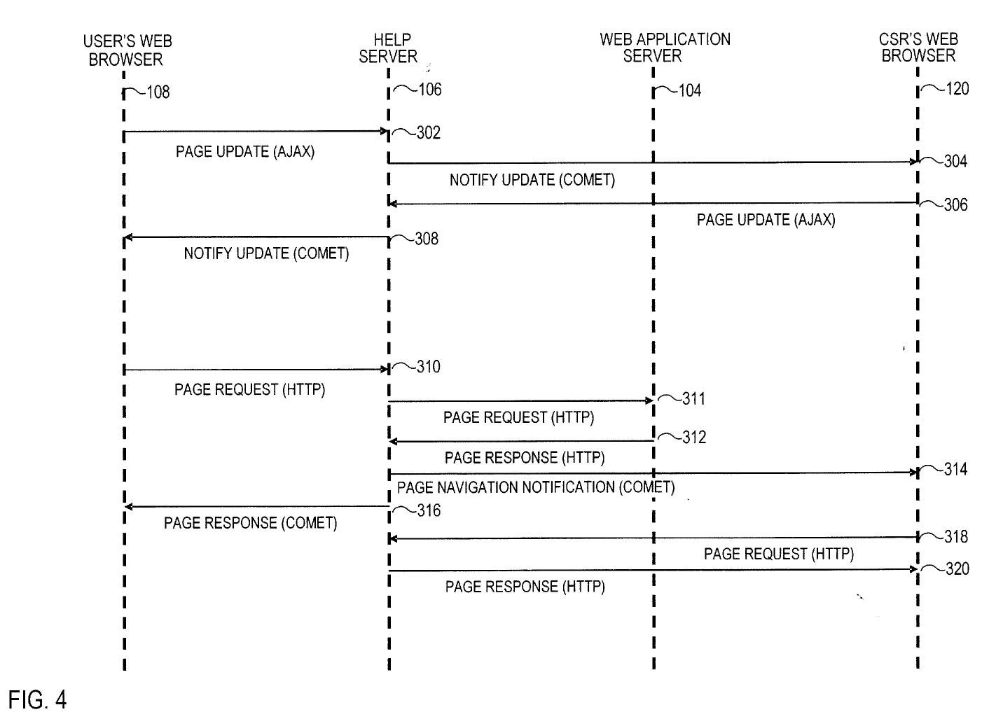

FIG. 4 depicts selected operations for establishing and operating a live communication session in accordance with disclosed embodiments. In operation 302, user web browser 108 provides a page update, for example using AJAX, to help server 106. In operation 304, help server 106 provides a NOTIFY update, for example using COMET, to CSR web browser 120. In turn, CSR web browser 120 provides a page update, for example using AJAX, to help server 106 in operation 306. Operation 308, as shown, relates to help server 106 providing a NOTIFY update, for example using COMET, to user web browser 108. In operation 310, user web browser 108 provides a page request, for example using HTTP, to help server 106. In turn, in operation 311, help server 106 provides a page request (for example using HTTP), to web application server 104. Web application server 104, in operation 312, provides a page response using HTTP for example, to help server 106. Help server 106 provides page navigation notification to CSR web browser 120 in operation 314. In operation 316, help server 106 provides page response (for example using COMET) to user web browser 108. Operation 318 relates to CSR web browser 120 providing a page request (for example using HTTP) to help server 106. In operation 320, help server 106 provides a page response (for example using HTTP) to CSR web browser 120.

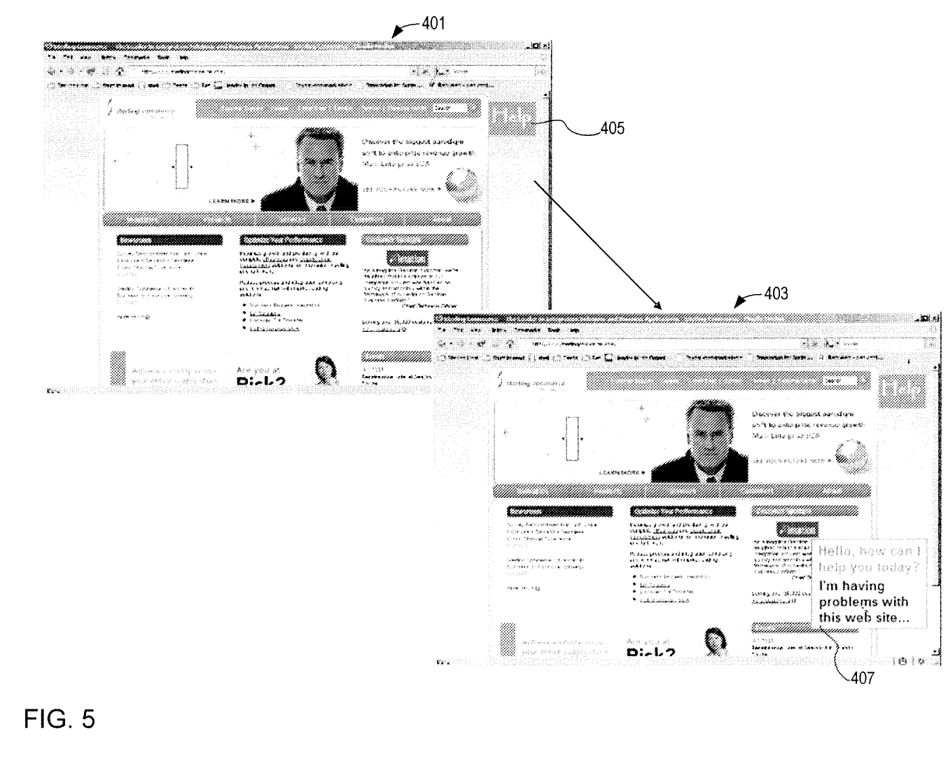

FIG. 5 depicts an example GUI 401 for initiating a real-time help service in accordance with disclosed embodiments. As shown, GUI 401 includes help icon 405. GUI 401 may be presented, for example, by user web browser 108 from FIGS. 4 and 5. In response to a user's request for help by activating or selecting icon 405 (i.e., providing user input or providing a user help request), GUI 403 is presented. As shown, GUI 403 includes dialog 407 which includes text from a customer service representative (e.g., “Hello, how can I help you today?”) and text from the user (e.g., “I'm having problems with this website . . . ”). Dialog 407 is produced in part over a communications channel that is established, in accordance with disclosed embodiments, in response to a user help request.

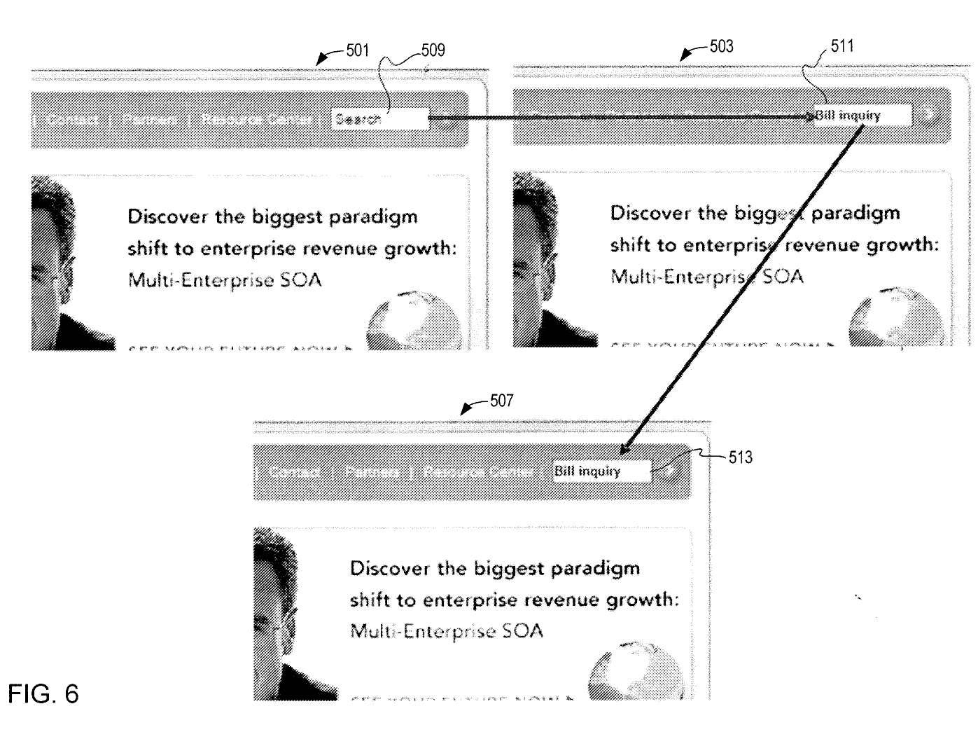

FIG. 6 illustrates an example screen shot 501 from a user's web browser. In addition, a further example screen shot 503 of the user's web browser is illustrated and a duplicate screen shot 507 (i.e., another instance of the screen shot) of the user's web browser is provided to the customer service representative in screen shot 503. As shown, a user viewing screen shot 501 enters the phrase “Bill inquiry” into text box 509, which appears to the user in text box 511 and substantially simultaneously in text box 513 from the customer service representative. In this way, the customer service representative is presented with data indicative of what the user is viewing at substantially the same moment (i.e., live or substantially in real time).

FIG. 7 illustrates an environment in which a user operating a user web browser 608 over a user network 605 gets real-time help services through help server proxying in accordance with disclosed embodiments. As shown, user web browser 608 communicates directly with help server proxy 607 that acts as a proxy to application server 604 and customer service representative browser 620. Communications with customer service representative browser 620 may be conducted, as shown, through help server queue 609, which resides on software provider network 602. As shown, communication between help server proxy 607 and customer service representative browser 620 occurs through network 626 (e.g., the Internet) over channel 622. In addition, a communication channel 624 may be established over the same network to allow personal communication between the user and the customer service representative. Communication channel 624 may be used for IM, VoIP protocols, or other forms of human communication.

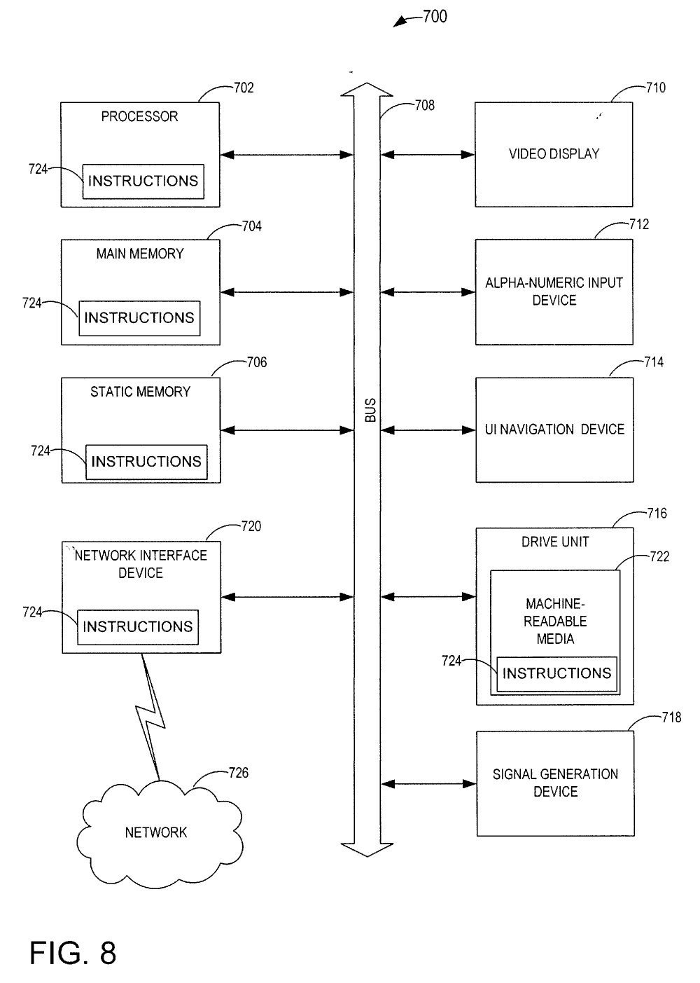

FIG. 8 illustrates in block diagram form a data processing system 700 within which a set of instructions may operate to perform one or more of the methodologies discussed herein. Data processing system 700 may operate as a standalone device or may be connected (e.g., networked) to other data processing systems. In a networked deployment, data processing system 700 may operate in the capacity of a server or a client data processing system in a server-client network environment, or as a peer computer in a peer-to-peer (or distributed) network environment. Example data processing systems include, but are not limited to a digital video recorder, a personal computer (PC), a tablet PC, set-top box, a cable box, a satellite box, an electronic programming guide box, a personal data assistant, a cellular telephone, a smart phone, a web appliance, a network router, a switch, a bridge, a server, or any machine capable of executing a set of instructions (sequential or otherwise) that specify actions to be taken by that machine. Further, while only a single data processing system is illustrated, the term “data processing system” shall also be taken to include any collection of data processing systems that individually or jointly execute a set (or multiple sets) of instructions to perform any one or more of the methodologies discussed herein.

As shown, data processing system 700 includes a processor 702 (e.g., a central processing unit, a graphics processing unit, or both), a main memory 704, and a static memory 706 that may communicate with each other via a bus 708. In some embodiments, the main memory 704 and/or the static memory 706 may be used to store the indicators or values that relate to multimedia content accessed or requested by a user. Data processing system 700 may further include a video display unit 710 (e.g., a television, a liquid crystal display or a cathode ray tube) on which to display multimedia content such as pay-per-view sporting events, television programs, video-on-demand movies, and the like. Data processing system 700 also includes an alphanumeric input device 712 (e.g., a keyboard or a remote control), a user interface (UI) navigation device 714 (e.g., a remote control or a mouse), a disk drive unit 716, a signal generation device 718 (e.g., a speaker) and a network interface device 720. The input device 712 and/or the UI navigation device 714 (e.g., the remote control) may include a processor (not shown), and a memory (not shown). The disk drive unit 716 includes a machine-readable medium 722 that may have stored thereon one or more sets of instructions and data structures (e.g., instructions 724) embodying or utilized by any one or more of the methodologies or functions described herein. The instructions 724 may also reside, completely or at least partially, within the main memory 704, within static memory 706, within network interface device 720, and/or within the processor 702 during execution thereof by the data processing system 700.

The instructions 724 may further be transmitted or received over a network 726 (e.g., a content provider) via the network interface device 720 utilizing any one of a number of transfer protocols (e.g., broadcast transmissions, HTTP). While the machine-readable medium 722 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine (i.e., data processing system) and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals.

While the disclosed systems may be described in connection with one or more embodiments, it is not intended to limit the subject matter of the claims to the particular forms set forth. On the contrary, disclosed systems are intended to include alternatives, modifications and equivalents as may be included within the spirit and scope of the subject matter as defined by the appended claims.

What is claimed is:

1. A help service comprising:
proxying a first instance of a web application page between a user web browser and a web application server in response to a user help request;
providing an instance of the web application page to a customer service representative web browser; and
opening a live communication channel for communication between a user and a customer service representative.

2. The help service of claim 1, wherein the user help request is generated and received within a user network, and wherein providing a second instance of the web application page includes transmitting the second instance of the web application page over the Internet.

3. The help service of claim 1, further comprising:
providing server-side processing to the customer service representative web browser, wherein the customer service representative web browser is a COMET client.

4. The help service of claim 3, wherein activity by the user generates a plurality of events, wherein the customer service representative web browser is a COMET client for receiving data indicative of a portion of the plurality of events.

5. The help service of claim 4, further comprising:
receiving server-side processing from the user web browser, wherein the user web browser is an AJAX server-side processor.

6. The help service of claim 5, further comprising:
receiving server-side processing from the customer service representative web browser,
wherein the customer service representative web browser is an AJAX server-side processor.

7. The help service of claim 3, further comprising:
providing server-side processing to the user web browser, wherein the user web browser is a COMET client for receiving updates to the first instance of the web application page.

8. A method of providing real-time help sessions, the method comprising:
establishing a browser channel through a help server between a customer service representative web browser and a user web browser in response to a user help request; and
establishing a communication channel for human communication between a user and a customer service representative.

9. The method of claim 8, wherein the communication channel bypasses the help server.

10. The method of claim 9, wherein the communication channel is for an instant message chat session.

11. The method of claim 9, wherein the communication channel is for voice over IP communication.

12. The method of claim 11, wherein the help server is within a software provider network that is for hosting the user application, and wherein the method further includes:
maintaining a COMET connection between the help server and the customer service representative web browser for sending data indicative of user actions through a help server queue module in a customer service representative network to the customer service representative web browser.

13. The method of claim 12, wherein the help server communicates with the customer service representative web browser over the Internet.

14. The method of claim 8, wherein the user help request results in the automated sending of user session identification information from the user web browser to the help server.

15. The method of claim 14, wherein the user help request results in generation of an automated request for an application server of the user application to send a refreshed page of a user application to the user web browser.

16. The method of claim 15 wherein, in response to the user help request, a refreshed page of the user application includes a JavaScript library that at least partially enables the browser channel.

17. The method of claim 16, wherein a version of the refreshed page is delivered to a web browser of the customer service representative, wherein the version includes a second JavaScript library for managing a COMET connection with a help server, wherein through the COMET connection user actions are pushed to the customer service representative's web browser substantially in real time.

18. A server for providing real-time help services for users of web applications, the server for executing computer readable instructions stored on at least one computer readable media for enabling the server to:
receive a user help request generated from the user web browser by a user selecting a help service;
request a web application page from a web application server to establish a proxy connection between a user web browser and a customer service representative web browser;
provide a first version of the web application page to the user web browser, wherein the first version includes computer instructions that enable a browser channel for pushing data indicative of user actions to the customer service representative web browser substantially in real time; and
provide a second version of the web application page to the customer service representative web browser, wherein the second version includes computer instructions for managing a COMET connection between a help server and the customer service representative web browser.

19. The server of claim 18, further comprising instructions for enabling the server to:
link the browser channel to a live communication channel, wherein the communication channel is for human communication between the user and the customer service representative.

20. The server of claim 19, wherein the live communication channel is an instant message chat channel.

21. The server of claim 19, wherein the live communication channel is a voice over IP communication channel.

22. The server of claim 21, further comprising instructions for enabling the server to:
communicate with the customer service representative web browser over the Internet using public key encryption.
